(19) United States
(12) Patent Application Publication
(10) Pub. No.: US 2021/0156531 A1
(43) Pub. Date: May 27, 2021

(54) EXTENSION CORD WITH LIGHTS RUNNING A FULL LENGTH FOR PRODUCING ILLUMINATION

(71) Applicant: Job Franklin Scroggins, Bessemer, AL (US)

(72) Inventor: Job Franklin Scroggins, Bessemer, AL (US)

(21) Appl. No.: 16/693,587

(22) Filed: Nov. 25, 2019

(51) Int. Cl. F21S 4/22; F21K 9/20; F21K 9/90; F21V 21/005; F21V 33/00; F21V 23/00; H01B 7/18; H01B 13/00

(52) U.S. Cl. CPC F21S 4/22; F21K 9/20; F21K 9/90; F21V 21/005; F21Y 2115/10; F21V 23/008; H01B 7/18; H01B 13/0036; F21V 33/0004

(57) ABSTRACT

A peripherally lighted extension cord is provided. The peripherally lighted extension cord sandwiches one or more lighting strips to an exterior of a cable sheath through application of a transparent coating or cover. The peripherally lighted extension cord provides a data board for selectively powering the one or more lighting strips.

### BACKGROUND OF THE INVENTION

The present invention relates to light sources and, more particularly, to an extension cord embodying peripheral lighting along its length.

When work is to be performed in a dark spaces, such as crawlspaces, attics, and the like, an extension cord must be run through the dark to the workspace wherein a drop light is hung, providing light, but only for the immediate area and not the dark path before and through the dark workspace. This, thus, requires that a flashlight of some sort must be carried to and from the work area prior to and even, in the case of very remote and/or large workspaces, while the drop light is powered.

Furthermore, the current approach of relying on ‘dark extension cords is that they are for (drop) light sources and so are not meant to deliver electricity for power tools, and the drop lights they do power have to be hung, requiring an elevated supporting object.

Additionally, if someone were to merely string light bulbs together on a pre-existing extension cord, like Christmas lights, this would not be practical for the application contemplated by the present invention. Such makeshift ‘lighted’ extension cords would be bulky (for example, such extension cords cannot be wrapped up and thrown into the bed of a truck), also their light bulbs could easily break in a work zone and/or go out, requiring a replacement as the user was left in the dark.

As can be seen, there is a need for an extension cord embodying peripheral lighting along its length for producing illumination along substantially the entire length so as to illuminate a path a worker needs to traverse from a lighted area through a dark space and up to the work zone. As a result, the present invention easily provides a lighted path from the entrance of the dark space to the work zone by the act of simply laying down the extension cord, which very likely is already going to be needed at the work zone for powering work tools. The extension cord embodied in the present invention delivers high voltage, while the peripheral lighting is protected under a transparent sheathing or coating, and so the present invention can literally be thrown in the dirt and forgotten about, like an extension cord, while only being slightly thicker than a traditional extension cord. As a result, the present invention can be handled and transported with ease, and the peripheral lighting can be long-lasting LEDs.

### SUMMARY OF THE INVENTION

In one aspect of the present invention, a peripherally lighted extension cord includes the following: a cable sheath housing a plurality of electrical conduits; the plurality of electrical conduits electrically connecting a power input and a power output; and one or more lighting strips disposed along an exterior surface of the cable sheath.

In another aspect of the present invention, the peripherally lighted extension cord includes the following: a cable sheath housing a plurality of electrical conduits; the plurality of electrical conduits electrically connecting a power input and a power output; one or more lighting strips disposed along an exterior surface of the cable sheath; a transparent coating sandwiching the one or more lighting strips to the exterior surface; and a data board for selectively powering the one or more lighting strips; and the plurality of electrical conduits electrically connecting a power input and the data board, wherein the one or more lighting strips include a plurality of lighting devices, and wherein a first intensity of one or more first lighting devices of the plurality of lighting devices adjacent to the power output is more intense than a second intensity of one or more second lighting devices of the plurality of lighting devices adjacent to the power input.

In yet another aspect of the present invention a method of improving an extension cord includes the following: providing an extension cord; applying one or more lighting strips against an exterior surface of the extension cord; electrically connecting the one or more lighting strips to a power input of the extension cord; and applying a transparent coating over the one or more lighting strips for furthering securing the one or more lighting strips to the exterior surface.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, in an assembled condition;

FIG. 2 is a perspective view of an exemplary embodiment of the present invention, demonstrating a section thereof;

FIG. 3 is a perspective view of an exemplary embodiment of an AC/DC component of the present invention;

FIG. 4 is a top view of an exemplary embodiment of the AC/DC component of the present invention; and

FIG. 5 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a peripherally lighted extension cord. The peripherally lighted extension cord sandwiches one or more lighting strips to an exterior of a cable sheath through application of a transparent cover or coat. The peripherally lighted extension cord provides a data board for selectively powering the one or more lighting strips.

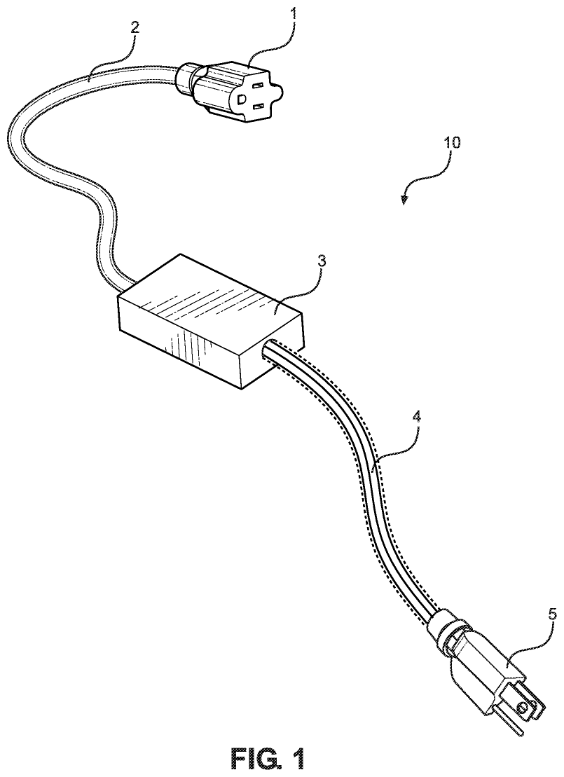

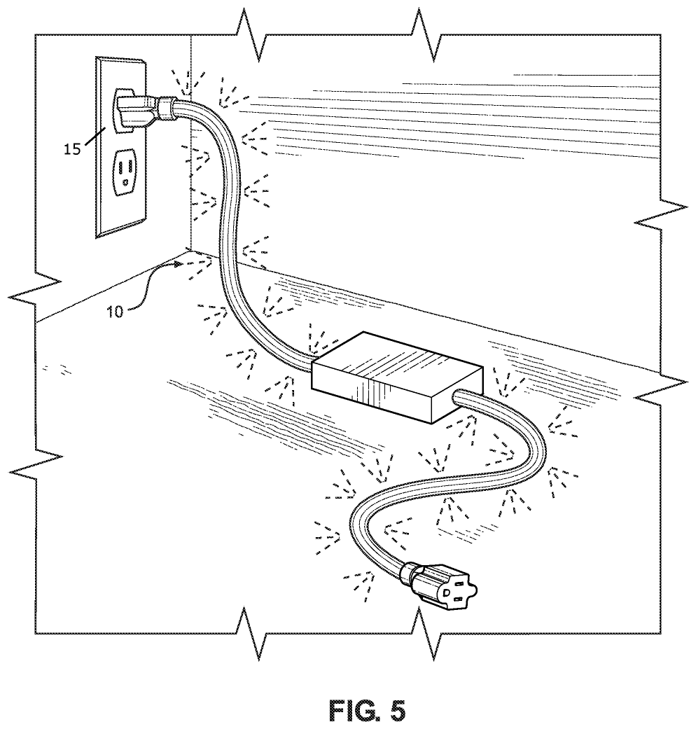

Referring to FIGS. 1 through 5, the present invention may include a peripherally lighted extension cord 10 having a load plug 1 on a first end and an electrical plug 5 on an opposing second end. Electrically interconnecting the first and second ends is an AC/DC converter 3 by way of an extension cables.

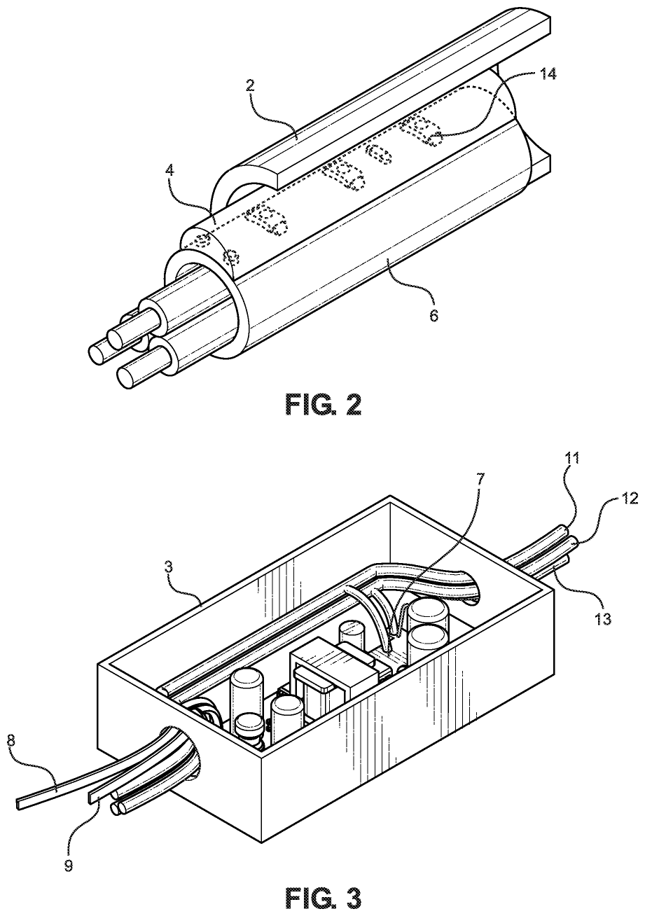

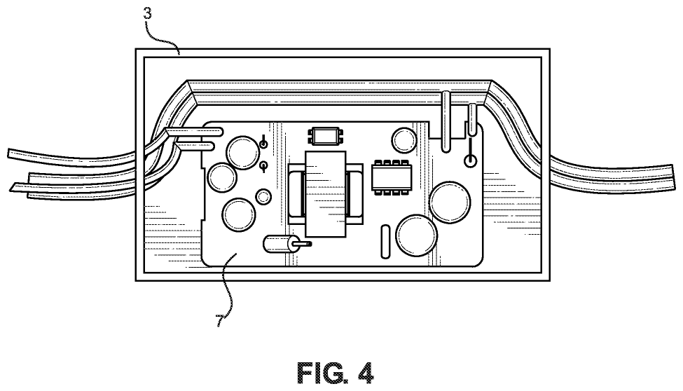

Referring to FIGS. 2 and 4, each extension cable may embody a cable sheath 6 that encompasses a lighting positive load 8, a lighting negative load 9, an insulated live conduit 11, an insulated ground conduit 12, and an insulated negative conduit 13. The live conduit 11 and the negative conduit 13 are adapted for transferring electricity from the electrical plug 5 to the load plug 1, by way of a power source 15, such as an electrical outlet. The lighting positive load 8 and the lighting negative load 9 are electrically coupled to the LED strip 4 and the data board 7. Electrical power is provided to the data board 7 by way of the live and negative conduits, 11 and 13.

Overlaying the cable sheath 6, is a lighting strip 4, and sandwiching the lighting strip 4 to the cable sheath 16 is an overlaying transparent coat 2. The lighting strip may be, but is not limited to, an LED strip.

Referring to FIGS. 3 and 4, the AC/DC converter 3 may include the data board 7. The AC/DC power converter 7 is adapted to selectively transfer electricity to the LED strip 4 by way of the data board 7, for providing alternating patterns and signals when powering the lighting strip 4. Accordingly, the lighting strip 4 may include a plurality of lighting devices 14 (such as, but not limited to, LED lights or AC-power lights) of different colors, intensity, and having more than one connection type with the data board 7. In certain embodiments, the lighting devices 14 may increase in intensity nearer to and/or more adjacent to the first end, so as to act as a de facto drop light.

The present invention may include one or more switches (not shown) to allow the user to turn on/off the lighting devices 14, a power outlet multiplier/extender (not shown), a drop light (not shown) at the first end, a surge protector (not shown) for protecting the load using power, and a trip breaker (not shown) for safety.

A method of using the present invention may include the following. The peripherally lighted extension cord 10 disclosed above may be provided. The peripherally lighted extension cord 10 is plugged into the power source 15 and laid/run to a work zone for powering a tool or a separate light source, along the way the plurality of light devices 14 circumferentially disposed along the extension cable traveling from the power source to the work zone, lights the work path and otherwise dark surrounding area for increasing the safety of the endeavor at hand. Obviously, the peripherally lighted extension cord 10 could be used as simply an extension cord instead of a light source.

It should be understood, of course, that the foregoing relates to exemplary embodiments of the invention and that modifications may be made without departing from the spirit and scope of the invention as set forth in the following claims.

1. A peripherally lighted extension cord, comprising:
a cable sheath having an interior surface and an exterior surface;
the cable sheath housing a plurality of electrical conduits in a lumen defined by the interior surface;
the plurality of electrical conduits electrically connecting a power input and a power output; and
one or more lighting strips secured to the exterior surface.

2. The peripherally lighted extension cord of claim 1, further comprising a transparent coating sandwiching the one or more lighting strips to the exterior surface.

3. The peripherally lighted extension cord of claim 1, further comprising a data board for selectively powering the one or more lighting strips;
and the plurality of electrical conduits electrically connecting the power input and the data board.

4. The peripherally lighted extension cord of claim 1, wherein the one or more lighting strips include a plurality of lighting devices, and wherein a first intensity of one or more first lighting devices of the plurality of lighting devices adjacent to the power output is more intense than a second intensity of one or more second lighting devices of the plurality of lighting devices adjacent to the power input.

5. A peripherally lighted extension cord, comprising:
a cable sheath having an interior surface and an exterior surface;
the cable sheath housing a plurality of electrical conduits inward of said interior surface;
the plurality of electrical conduits electrically connecting a power input and a power output;
one or more lighting strips secured to the exterior surface;
a transparent coating sandwiching the one or more lighting strips to the exterior surface; and
a data board for selectively powering the one or more lighting strips; and the plurality of electrical conduits electrically connecting [a]the power input and the data board, wherein the one or more lighting strips include a plurality of lighting devices, and wherein a first intensity of one or more first lighting devices of the plurality of lighting devices adjacent to the power output is more intense than a second intensity of one or more second lighting devices of the plurality of lighting devices adjacent to the power input.

6. A method of improving an extension cord, the method comprising:
providing an extension cord;
securing one or more lighting strips to an exterior surface of the extension cord, wherein the exterior surface is defined by an outer radius of a cable sheath, and wherein a positive load and a negative load for the one or more lighting strips are housed in a lumen of the cable sheath, the lumen defined by an inner radius of the cable sheath; and
electrically connecting the one or more lighting strips to a power input of the extension cord.

7. The method of claim 6, further comprising:
applying a transparent coating over the one or more lighting strips for furthering securing the one or more lighting strips to the exterior surface.

8. The peripherally lighted extension cord of claim 5, wherein the cable sheath is the only cable sheath of the peripherally lighted extension cord.
